(19) United States
(12) Patent Application Publication
(10) Pub. No.: US 2026/0361600 A1
(43) Pub. Date: Nov. 12, 2026

(54) Method for Table Entry Consistency Verification, Electronic Device and Storage Medium

(71) Applicant: CLOUD INTELLIGENCE ASSETS HOLDING (SINGAPORE) PRIVATE LIMITED, Singapore (SG)

(72) Inventors: Jianyuan LU, Hangzhou, Zhejiang (CN); Biao LYU, Hangzhou, Zhejiang (CN); Shunmin ZHU, Hangzhou, Zhejiang (CN)

(21) Appl. No.: 19/130,438

(22) PCT Filed: Nov. 15, 2023
(86) PCT No.: PCT/CN2023/131896

§ 371 Date: May 15, 2025

(30) Foreign Application Priority Data
Nov. 15, 2022 (CN) 202211426711.6

(51) Int. Cl. H04L 41/0866; H04L 41/40; H04L 69/04

(52) U.S. Cl. CPC H04L 41/0866; H04L 41/40; H04L 69/04

(57) ABSTRACT

The present disclosure provides a method for table entry consistency verification, an electronic device and a storage medium. The method includes that: a data plane node of an SDN at least performs probability compression on at least entries of a first configuration table, to obtain a compressed first configuration table and sends the compressed first configuration table to a control plane, and the control plane compares a second configuration table with the compressed first configuration table, and determines whether the at least entries of the first configuration table are consistent with at least entries of the second configuration table according to a comparison result.

The present disclosure claims priority of Chinese Patent Application No. 202211426711.6, filed to China National Intellectual Property Administration on Nov. 15, 2022 and titled “Method for Table Entry Consistency Verification, Electronic Device and Storage Medium”, the content of which is hereby incorporated by reference in its entirety.

### TECHNICAL FIELD

The present disclosure relates to the field of cloud computer technology, and in particular, to a method for table entry consistency verification, an electronic device and a storage medium.

### BACKGROUND OF THE INVENTION

Currently, a cloud computing data center manages networks through the means of Software Defined Networking (SDN). The SDN separates a control plane of a network from a data plane of the network. The control plane is centralized and is responsible for planning and distributing configurations of the network. The data plane is distributed, receives configurations from the control plane and is responsible for packet forwarding. In theory, the configuration planned by the control plane should be entirely consistent with the actual configuration on the data plane. However, in practice, due to software or hardware errors in either the control plane or the data plane, there are occasional instances where the configuration on the data plane is not entirely consistent with configuration on the control plane, which can lead to network anomalies or failures. Therefore, an SDN network is required to have the capability to check table entry consistency between the control plane and the data plane.

In most cases, network configuration tables of each node on the data plane are replicated and then sent to the control plane. The replicated configuration tables are compared with original configuration tables on the control plane. Consistency check for network configurations is performed by traversing entries of two tables. In a large-scale public cloud scenario, tenant-based network configurations are very numerous, and completing a single table entry comparison can take tens of minutes, thereby resulting in lower efficiency.

### SUMMARY OF THE INVENTION

Embodiments of the present disclosure provide a method for table entry consistency verification, an electronic device and a storage medium to reduce consistency verification time for table entries between a data plane and a control plane and improve checking efficiency.

In a first aspect, the embodiments of the present disclosure provide a method for table entry consistency verification, which is applied to a data plane node in an SDN. The method includes that: probabilistic compression is at least performed on at least entries of a first configuration table, to obtain a compressed first configuration table; the compressed first configuration table is sent to a control plane, thereby enabling the control plane to: compare a second configuration table with the compressed first configuration table, and determine whether the at least entries of the first configuration table are consistent with at least entries of the second configuration table based on the comparison result.

In a second aspect, the embodiments of the present disclosure provide another method for table entry consistency verification, which is applied to a control plane of an SDN. The method includes that: a compressed first configuration table sent by a data plane node is received, the compressed first configuration table being obtained through at least performing, by the data plane node, probabilistic compression on at least entries of the first configuration table; a second configuration table is compared with the compressed first configuration table to determine whether the at least entries of the first configuration table are consistent with at least entries of the second configuration table based on the comparison result.

In a third aspect, the embodiments of the present disclosure provide an apparatus for table entry consistency verification, which is applied to a data plane node in an SDN. The apparatus includes: a compression module arranged for at least performing probabilistic compression on at least entries of a first configuration table, to obtain a compressed first configuration table; a sending module arranged for sending the compressed first configuration table to a control plane, thereby enabling the control plane to: compare a second configuration table with the compressed first configuration table, and determine whether the at least entries of the first configuration table are consistent with at least entries of the second configuration table based on the comparison result.

In a fourth aspect, the embodiments of the present disclosure provide another apparatus for table entry consistency verification, which is applied to a control plane of an SDN. The apparatus includes: a receiving module arranged for receiving a compressed first configuration table sent by a data plane node, the compressed first configuration table being obtained through at least performing, by the data plane node, probabilistic compression on at least entries of the first configuration table; a comparison module arranged for comparing a second configuration table with the compressed first configuration table, and determining whether the at least entries of the first configuration table are consistent with at least entries of the second configuration table based on the comparison result.

In a fifth aspect, the embodiments of the present disclosure provide an electronic device, including a memory, a processor, and a computer program stored on the memory, where when executing the computer program, the processor implements the method provided by any embodiment of the present disclosure.

In a sixth aspect, the embodiments of the present disclosure provide a computer-readable storage medium, where the computer-readable storage medium stores a computer program, and when executing the computer program, the processor implements the method provided by any embodiment of the present disclosure.

The above description is an overview of the technical solutions of the present disclosure. To better understand the technical means of the present disclosure, reference can be made to the content of the specification for implementation, and to make the aforementioned and other purposes, features, and advantages of the present disclosure more clearly understandable, specific embodiments of the present disclosure are particularly exemplified below.

### BRIEF DESCRIPTION OF DRAWINGS

In the accompanying drawings, unless otherwise specified, the same drawing reference numerals throughout the various drawings indicate the same or similar parts or elements. The drawings are not necessarily to scale. It should be understood that these drawings depict some embodiments according to the present disclosure and should not be considered as limiting the scope of the present disclosure.

FIG. 1 is a schematic diagram of a system architecture of an SDN network according to some embodiments of the present disclosure.

FIG. 2 is a schematic diagram of a method for table entry consistency verification according to some embodiments of the present disclosure.

FIG. 3 is a schematic diagram of another method for table entry consistency verification according to some embodiments of the present disclosure.

FIG. 4 is a flowchart of a method for table entry consistency verification according to some embodiments of the present disclosure.

FIG. 5 is a flowchart of another method for table entry consistency verification according to some embodiments of the present disclosure.

FIG. 6 is a schematic diagram of probabilistic compression performed by a data plane node using a Bloom Filter according to some embodiments of the present disclosure.

FIG. 7 is a schematic diagram of table entry queries on a control plane according to some embodiments of the present disclosure.

FIG. 8 is a structural block diagram of an apparatus for table entry consistency verification according to some embodiments of the present disclosure.

FIG. 9 is a structural block diagram of another apparatus for table entry consistency verification according to some embodiments of the present disclosure.

FIG. 10 is a block diagram of an electronic device according to some embodiments of the present disclosure.

### DETAILED DESCRIPTION OF THE INVENTION

In the following text, certain exemplary embodiments are simply described. As a person having ordinary skill in the art can recognize, the described embodiments may be modified in various different ways without departing from the conception or scope of the present disclosure. Therefore, the drawings and description are considered to be illustrative in nature rather than restrictive.

To facilitate understanding of the technical solutions of the embodiments of the present disclosure, explanations of technologies relevant to the embodiments of the present disclosure are provided below. The following related art can be combined arbitrarily with the technical solutions of the embodiments of the present disclosure as optional solutions, all of which fall within the protection scope of the embodiments of the present disclosure.

The technical solution of the present disclosure can be applied to table entry consistency verification of a data plane and a control plane of an SDN. FIG. 1 is a schematic diagram of a system architecture of an SDN network according to some embodiments of the present disclosure. As shown in FIG. 1, an overall architecture of the SDN is divided from bottom to top into the data plane, the control plane and an application plane. In the SDN, the control plane is centralized, and the data plane is distributed. The data plane includes multiple nodes, and each node is a switch or other terminal devices. The data plane receives configuration from the control plane, and the data plane is responsible for packet forwarding to implement service functions of the application plane, such as load balancing, access control, application acceleration, etc. In theory, the configuration planned by the control plane should be completely consistent with the actual configuration of the data plane. However, in practice, due to software or hardware errors in the control plane or the data plane, situations where the actual configuration of the data plane is not entirely consistent with the configuration planned by the control plane may occur. Once such inconsistency in table entries happens, the forwarding behavior of the network will not match expectations, leading to network anomalies or network failures. Therefore, the capability for the table entry consistency verification between the control plane and data plane is required, allowing for rapid discovery and repair when the inconsistency in table entries happens.

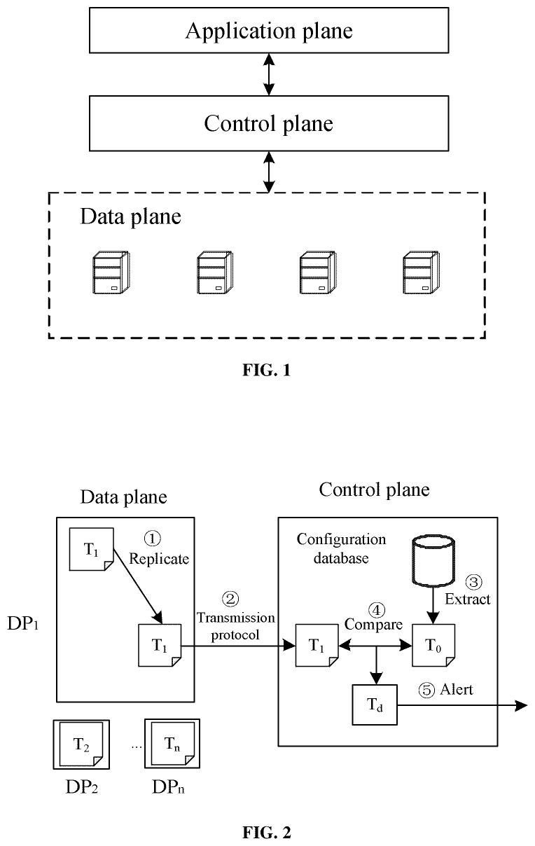

In the related art, network table entry consistency verification is performed by completely comparing two network configuration tables, as shown in FIG. 2. The centralized control plane (CP) has full network configuration stored in a configuration database. The distributed data plane (DP) has n nodes (DP1, DP2, . . . , DPn), each of which respectively receives configuration tables (T1, T2, . . . , Tn) from the control plane and stores locally. Taking a data plane node DP1 as an example, a copy T1 of the network configuration table of the data plane node DP1 is obtained. The copy T1 is sent from the data plane node DP1 to the control plane via a transmission protocol. An original network configuration table T0 is extracted from the configuration database, and then at the control plane, it is determined whether the table entries of copy T1 are compared with the table entries of the original network configuration table T0. For instance, one method for table entry comparison includes the following steps. Through traversing two configuration tables (T1 and T0), an inconsistent table entry Td can be found. Finally, when Td is not empty, an alert notification is sent to a terminal device of network maintenance personnel. This type of table entry consistency comparison requires a significant amount of time when the number of table entries in the configuration tables is large, resulting in low processing efficiency.

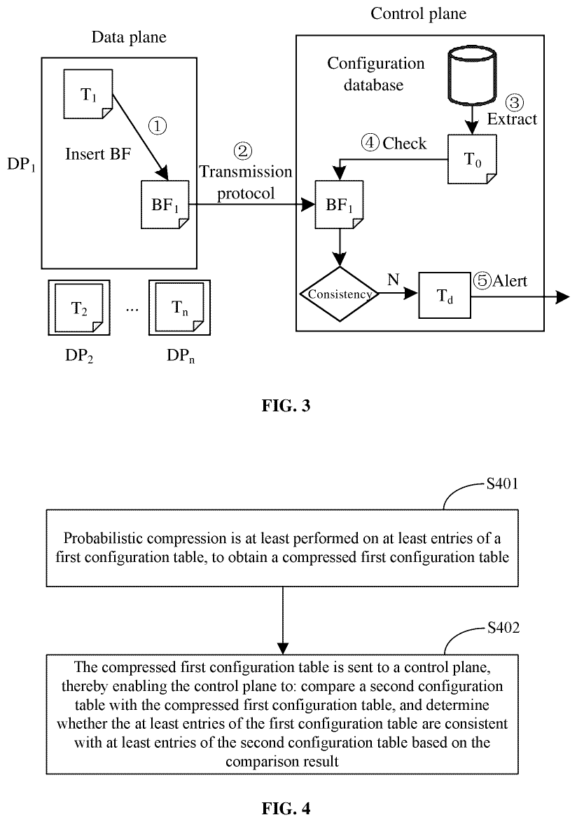

The embodiments of the present disclosure provide a method for checking consistency of table entries, as shown in FIG. 3, involving probabilistic compression of configuration tables in the data plane nodes, for example, using a Bloom Filter (BF) to achieve probabilistic compression. A Bloom filter consists of a binary vector and a series of random mapping functions and can be used to check whether an element is in a set. The probabilistic compression of the embodiments of the present disclosure utilizes the basic principle of Bloom filters, combined with the specific requirements of the present disclosure, determining the computational results of the Bloom filter according to the application scenario and computed data. In one embodiment, this includes: in the data plane node, compressing the configuration table T1 into Bloom Filter BF1 and transmitting through a transmission protocol to the control plane, the transmission protocol can include Secure Shell (SSH), Simple Control Protocol (SCP), etc. The control plane extracts the original network configuration table T0 from the configuration database, checks whether each item of T0 is in BF1, and determines the consistency of table entries based on the check results. When there exist inconsistent table entries Td, an alert notification is issued to the terminal device of network maintenance personnel. In this embodiment, through performing probabilistic compression on the configuration table, the bandwidth required for transmitting table configurations is reduced. For example, the compression ratio can be 20 times, compressing 2 GB of table configurations to 100 MB, reducing the amount of data which is required to be transmitted between the control plane and data plane, improving system operational efficiency. Moreover, querying whether items of the original network configuration table are in the compressed configuration table, compared to traversing the items of two configuration tables, reduces the time for comparison, shortening the time for consistency checks of millions of table entries from tens of minutes to within one minute, thus enhancing the efficiency of table entry consistency checks.

The embodiments of the present disclosure provide a method for table entry consistency verification. FIG. 4 is a flowchart of a method for table entry consistency verification according to some embodiments of the present disclosure. The method includes the following steps.

In step S401, probabilistic compression is at least performed on at least entries of a first configuration table, to obtain a compressed first configuration table.

The method provided by some embodiments can be deployed in a data plane node of the SDN. The data plane node is a switch or other terminal device. The first configuration table is a configuration table issued from the control plane to the data plane. The configuration table includes multiple table entries, and the multiple table entries can be any dimensional information which is required to be configured in network configurations, such as, Internet Protocol Address (IP) and so on.

In some embodiments, the probabilistic compression can be achieved through a Bloom Filter. An operation of performing the probabilistic compression based on the table entries of the configuration table in the data plane node includes the following steps. Each table entry of the configuration table is traversed, and the each table entry is inserted as a key value into the BF to output a BF written file, namely the compressed first configuration table.

In step S402, the compressed first configuration table is sent to a control plane, thereby enabling the control plane to: compare a second configuration table with the compressed first configuration table, and determine whether the at least entries of the first configuration table are consistent with at least entries of the second configuration table based on the comparison result.

The second configuration table is an original network configuration table stored on the control plane. The compressed first configuration table is sent to the control plane, and the control plane compares the second configuration table with the compressed first configuration table. In some embodiments, when the data plane node performs the probabilistic compression through the Bloom Filter, the control plane queries each table entry of the original network configuration table in the BF written file. When at least one table entry is not in the BF written file, it is indicated that the inconsistency is existed between the at least entries of the first configuration table and the table entries of second configuration table.

In some embodiments, through performing the probabilistic compression on the configuration table, the transmitting bandwidth required for table entry configurations can be reduced, thereby improving data transmission efficiency. Additionally, the control plane queries each table entry of the second configuration table in the compressed first configuration table. When the number of table entries in the second configuration table is n, it is determined whether or not the consistency between the first configuration table and the second configuration table through n queries. When comparing the table entries of two configuration tables, n×n queries are required. The table entry checking method of some embodiments can reduce query time and improve checking efficiency.

Through the method for table entry consistency verification provided by the embodiments of the present disclosure, the data plane node of the SDN at least performs the probability compression on at least entries of the first configuration table, to obtain the compressed first configuration table and sends the compressed first configuration table to the control plane, and the control plane compares the second configuration table with the compressed first configuration table, and determines whether the at least entries of the first configuration table are consistent with at least entries of the second configuration table according to a comparison result. In embodiments of the present disclosure, time for data transmission can be reduced by performing the probability compression on the first configuration table and sending the compressed first configuration table to the control plane; and the comparison complexity and time for comparison can be reduced by comparing the second configuration table with the compressed first configuration table, thereby shortening time for table entry consistency verification of configuration tables having ten million-level table entries from tens of minutes to less than one minute, thus improving the table entry consistency verification efficiency of the data plane and the control plane.

One implementation method of the aforementioned step S401 is shown in the following embodiment.

In some embodiments, an operation of performing the probabilistic compression on the at least entries of the first configuration table to obtain the compressed first configuration table includes the following steps. The at least entries of the first configuration table is calculated based on a hash function to obtain multiple first hash values. A first bit vector, as the compressed first configuration table, corresponding to the first configuration table is obtained based on the multiple first hash values, where the multiple first hash values corresponding bit by bit to the first bit vector.

In practical applications, the first configuration table includes the multiple table entries. Using the hash function, the hash calculation is performed on each table entry to obtain a first hash value corresponding to each table entry. The multiple first hash values corresponding to the multiple table entries are mapped to respective bit positions of the first bit vector, with the multiple first hash values and the bit positions in the first bit vector being one-to-one correspondence. For example, initial values of the bit positions in the first bit vector are 0, and after mapping to the corresponding bit positions, values of the corresponding bit positions are 1. In some embodiments, the probabilistic compression of the first configuration table is performed through the BF. Each table entry is inserted into the BF to obtain the first bit vector. In some embodiments, through performing the probabilistic compression on the first configuration table and transmitting the compressed first configuration table to the control plane, the transmitting bandwidth required for table entry configurations can be reduced, thereby improving the data transmission efficiency.

How to calculate the multiple first hash values based on the at least entries of the first configuration table is shown in the following embodiment.

In some embodiments, an operation of calculating the at least entries of the first configuration table based on the hash function to obtain the multiple first hash values includes the following steps. Multiple first hash parameters are randomly generated, and the at least entries of the first configuration table and the multiple first hash parameters are calculated based on the hash function to obtain the multiple first hash values corresponding to the at least entries of the first configuration table.

In practical applications, each of the multiple first hash parameters is a seed of a hash function generated using a random function. The same hash function can be used for respectively calculating one table entry and multiple seeds to obtain the multiple first hash values. When using the BF for the probabilistic compression, the seed of the hash function randomly generated causes the false positive probability of multiple rounds of iterative table entry comparisons to decay exponentially.

The false positive of the BF indicates that there is no corresponding table entry in the BF, but a query result shows that there is a corresponding table entry. When the data plane actually experiences missing table entries or incorrect table entry fields, there is a certain probability that the query result is wrong. To reduce the probability of false positives, in some embodiments, the seed of the hash function is randomly selected so that two consecutive table entry comparisons are independent, thereby improving the accuracy of the query result. For example, setting the false positive probability of the BF to f<10\hat{ }-8, when a false positive occurs, the second occurrence of the false positive for the same table entry has a probability of f<10\hat{ }-16, and the third occurrence has a probability of f<10\hat{ }-24, and so on. That is, the false positive probability decays exponentially with 10\hat{ }-8 as the base. After two or three rounds of iteration, erroneous table entries can be discovered.

Additionally, for each table entry, the multiple hash values are generated using the same hash function and the multiple seeds, which is more convenient compared with generating the multiple hash values using the multiple hash functions. When the multiple hash functions are used for generating the multiple hash values, the multiple hash functions are required to be randomly selected from a set of hash functions, which requires a lot of hash functions, resulting in time-consuming and labor-intensive.

Besides checking the table entries of the two configuration tables, the fields of table entries are further checked, which is shown in the following embodiment for details.

In some embodiments, an operation of at least performing the probabilistic compression on the at least entries of the first configuration table to obtain the compressed first configuration table includes the following step. The probabilistic compression is performed based on the at least entries of the first configuration table and fields of the at least entries of the first configuration table, to obtain the compressed first configuration table.

In practical applications, the table entries and the fields of the at least entries of the first configuration table are respectively inserted into the BF to obtain the BF written file, which is set as the compressed first configuration table. After sending the BF written file to the control plane, the control plane checks, based on the BF written file, whether or not the table entries and the fields of the at least entries of the first configuration table are consistent with the table entries and the fields of the at least entries of the second configuration table. When a table entry is an IP address, fields of this table entry includes vip (gateway address), tunnel-id (tunnel ID), region (region), bandwidth-id (bandwidth), type-id (type), sg-in (ingress security group), sg-out (egress security group), sg-all (blocking type), tos (type of service) and so on. In some embodiments, through performing the probabilistic compression based on the table entries and the fields of table entries and conducting table entry consistency verification, it is convenient to simultaneously check for missing table entry anomalies and incorrect table entry field configuration anomalies.

In some embodiments, an operation of performing the probabilistic compression on the at least entries of the first configuration table and the fields of the at least entries of the first configuration table to obtain the compressed first configuration table includes the following steps. Multiple second hash values are determined based on a concatenated string obtained by concatenating the at least entries of the first configuration table and the fields of the at least entries of the first configuration table. A second bit vector, as the compressed first configuration table, corresponding to the first configuration table is obtained based on the multiple first hash values and the multiple second hash values obtained by calculating the at least entries of the first configuration table using the hash function, where the multiple first hash values and the multiple second hash values respectively corresponding bit by bit to the second bit vector.

In practical applications, the table entries and the fields of table entries are concatenated to obtain the concatenated string. For example, when the table entry is the IP address and the fields of this table entry are the bandwidth, the region, and the gateway address, the concatenated string includes IP address+bandwidth+region+gateway address. The means for concatenating the concatenated string includes multiple concatenation methods, and this is not restricted.

Based on the concatenated string, the hash calculation is performed to obtain the multiple second hash values. Based on the hash function, the hash calculation is performed on the table entries to obtain the multiple first hash values. The multiple first hash values and the multiple second hash values are mapped to bit positions of the second bit vector, with each hash value correspondingly mapped to one bit position. The multiple first hash values and the bit positions in the second bit vector are in one-to-one correspondence. The multiple second hash values and the bit positions in the second bit vector are further in one-to-one correspondence. For example, initial values of the bit positions in the second bit vector are 0, and after mapping the multiple first hash values and the multiple second hash values to the corresponding bit positions, the values of the corresponding bit positions are 1.

In some embodiments, an operation of determining the multiple second hash values based on the concatenated string obtained by concatenating the at least entries of the first configuration table and the fields of the at least entries of the first configuration table includes the following step. Multiple second hash parameters are randomly generated, and the concatenated string and the multiple second hash parameters are calculated based on the hash function to obtain the multiple second hash values corresponding to the concatenated string.

In practical applications, each of the multiple second hash parameters is a seed of the hash function generated using a random function. The same hash function can be used for respectively calculating one concatenated string and multiple seeds, to obtain the multiple first hash values. When using the BF for the probabilistic compression, randomly generating the seed of the hash function causes the false positive probability of multiple rounds of iterative table entry comparisons to decay exponentially. Additionally, for each concatenated string, generating multiple hash values using the same hash function and the multiple seeds is more convenient compared with generating multiple hash values using multiple hash functions. When the multiple hash functions are used for generating the multiple hash values, the multiple hash functions are required to be randomly selected from a set of hash functions, and constructing this set using a lot of hash functions, resulting in time-consuming and labor-intensive.

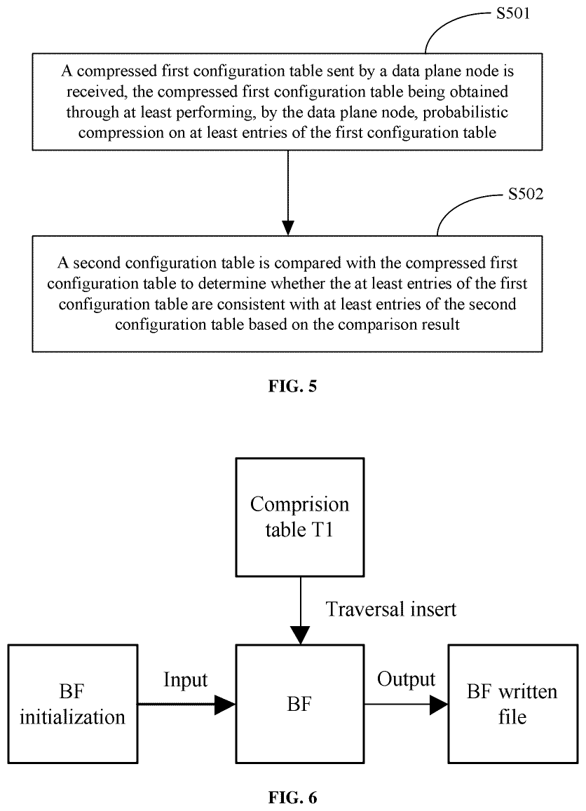

Corresponding to above-mentioned method provided by the embodiments of the present disclosure, FIG. 5 is a flowchart of another method for table entry consistency verification according to some embodiments of the present disclosure. The method includes the following steps.

In step S501, a compressed first configuration table sent by a data plane node is received, the compressed first configuration table being obtained through at least performing, by the data plane node, probabilistic compression on at least entries of the first configuration table.

The method provided by some embodiments can be deployed in a control plane of the SDN. The control plane is a server or other terminal device. The first configuration table is a configuration table issued from the control plane to the data plane, so that the data plane performs the probabilistic compression on the first configuration table to obtain the compressed first configuration table.

The probabilistic compression can be achieved through a Bloom Filter. An operation of performing the probabilistic compression based on the table entries of the configuration table in the data plane node includes the following steps. Each table entry of the configuration table is traversed, and the each table entry is inserted as a key value into the BF to output a BF written file, namely the compressed first configuration table.

In step S502, a second configuration table is compared with the compressed first configuration table to determine whether the at least entries of the first configuration table are consistent with at least entries of the second configuration table based on the comparison result.

The second configuration table is an original network configuration table stored on the control plane. The data plane node sends the compressed first configuration table to the control plane, and the control plane compares the second configuration table with the compressed first configuration table and determines whether the at least entries of the first configuration table are consistent with the at least entries of the second configuration table.

Through the method for table entry consistency verification provided by the embodiments of the present disclosure, the data plane node of the SDN at least performs the probability compression on at least entries of a first configuration table, to obtain the compressed first configuration table and sends the compressed first configuration table to the control plane, and the control plane compares the second configuration table with the compressed first configuration table and determines whether the at least entries of the first configuration table are consistent with at least entries of the second configuration table according to a comparison result. In embodiments of the present disclosure, time for data transmission can be reduced by performing the probability compression on the first configuration table and sending the compressed first configuration table to the control plane; and the comparison complexity and time for comparison can be reduced by comparing the second configuration table with the compressed first configuration table, thereby shortening time for table entry consistency verification of configuration tables having ten million-level table entries from tens of minutes to less than one minute, thus improving the table entry consistency verification efficiency of the data plane and the control plane.

In some embodiments, an operation of comparing the second configuration table with the compressed first configuration table, and determining whether the at least entries of the first configuration table are consistent with the at least entries of the second configuration table based on the comparison result includes the following steps. Whether the at least entries of the second configuration table are in the compressed first configuration table is queried, and in response to the at least entries of the second configuration table being in the compressed first configuration table, it is determined that the at least entries of the first configuration table are consistent with the at least entries of the second configuration table.

In practical applications, when the data plane node performs the probabilistic compression through a Bloom Filter, each table entry is inserted into the BF as a key value to output the BF written file to the control plane. The control plane queries each table entry of the original configuration table in the BF written file. When all the table entries are found, the at least entries of the first configuration table are consistent with the at least entries of the second configuration table.

In some embodiments, the data plane uses the hash function to perform hash calculation on each table entry to obtain a first hash value corresponding to each table entry. The first hash values corresponding to the multiple table entries are mapped to respective bit positions of the first bit vector, with the first hash values and the bit positions in the first bit vector being in one-to-one correspondence. For instance, the initial values of the bit positions in the first bit vector are 0, and after mapping to the corresponding bit positions, the values of the corresponding bit positions are 1. For any table entry in the second configuration table, the control plane queries whether a value at the corresponding bit position in the first bit vector for this table entry is 1. When the value is 1, it is indicated that the table entry of the second configuration table is in the compressed first configuration table. The bit position corresponding to this table entry in the second configuration table is the same as the bit position corresponding to this table entry in the first configuration table.

In some embodiments, the control plane queries each table entry of the second configuration table in the compressed first configuration table. When the number of the table entries in the second configuration table is n, and each table entry is queried once, consistency between the first configuration table and the second configuration table is determined through n queries.

When comparing the table entries of two configuration tables, n×n queries are required. Therefore, the table entry checking method provided by some embodiments can reduce query time and improve inspection efficiency.

In some embodiments, an operation of in response to the compressed first configuration table being obtained through performing the probabilistic compression based on the at least entries of the first configuration table and the fields of the at least entries of the first configuration table, comparing the second configuration table with the compressed first configuration table, and determining whether the at least entries of the first configuration table are consistent with the at least entries of the second configuration table based on the comparison result includes the following steps. In response to the at least entries of the second configuration table being in the compressed first configuration table, whether the fields of the at least entries of the first configuration table are in the compressed first configuration table is queried, and in response to the fields of the at least entries of the first configuration table being in the compressed first configuration table, it is determined that the at least entries of the first configuration table are consistent with the at least entries of the second configuration table.

In practical applications, the data plane node respectively inserts the table entries and the fields of at least entries of the first configuration table into the BF to obtain the BF written file, which is set as the compressed first configuration table. After sending the BF written file to the control plane, the control plane checks, based on the BF written file, whether the table entries and the fields of the at least entries of the first configuration table are consistent with the table entries and the fields of the at least entries of the second configuration table. First, the at least entries of the second configuration table are queried in the BF written file. When a table entry is found in the BF written file, it is determined whether the fields of this table entry are in the BF written file. When the fields of this table entry are in the BF written file, it is indicated that the table entries and the fields of the at least entries of the first configuration table are consistent with the table entries and the fields of the at least entries of the second configuration table. In some embodiments, the data plane performs hash calculation on the concatenated string obtained by concatenating the table entries and the fields of table entries to obtain the multiple second hash values. The table entries are calculated based on the hash function to obtain the multiple first hash values. The multiple first hash values and the multiple second hash values are mapped to respective bit positions of the second bit vector, with each hash value correspondingly mapped to one bit position. The first hash values and the bit positions in the second bit vector are in one-to-one correspondence, and the second hash values and the bit positions in the second bit vector are further in one-to-one correspondence. For instance, the initial values of the bit positions in the second bit vector are 0, and after mapping the multiple first hash values and the multiple second hash values to the corresponding bit positions, the values of the corresponding bit positions are 1. For any table entry of the second configuration table, the control plane queries whether the value at the corresponding bit position in the second bit vector for this table entry or the fields of this table entry is 1. When the value is 1, it is indicated that this table entry or the fields of this table entry of the second configuration table is in the compressed first configuration table. The bit position corresponding to this table entry or the fields of this table entry of the second configuration table can be the same as the bit position corresponding to this table entry or the fields of this table entry of the first configuration table.

In some embodiments, an operation of in response to the compressed first configuration table being obtained through performing the probabilistic compression based on the at least entries of the first configuration table and the fields of the at least entries of the first configuration table, comparing the second configuration table with the compressed first configuration table, and determining whether the at least entries of the first configuration table are consistent with the at least entries of the second configuration table based on the comparison result includes the following step. In response to the table entries or fields of the at least entries of the second configuration table being not in the compressed first configuration table, an inconsistency notification message for the at least entries of the second configuration table is generated, the inconsistency notification message including the table entries or fields of the at least entries of the second configuration table being not found in the compressed first configuration table.

In practical applications, when the compressed first configuration table is obtained through performing the probabilistic compression based on the table entries and the fields of the table entries, the consistency of table entries is determined according to the a checking result. When some table entries are not found, it indicates inconsistency of table entries to output the inconsistent table entries. When some fields of the table entries are not found, the fields of the table entries that are not found are output. When some table entries are inconsistent or some fields of the table entries are inconsistent, the inconsistency notification message for the table entries, which includes the at least entries of the second configuration table that are not found in the compressed first configuration table, is generated. The control plane sends the inconsistency notification message for the table entries to the terminal device of network maintenance personnel for timely adjustment to avoid network anomalies or network failures.

To better understand the technical concept of the present disclosure, the implementation process of the technical solution is introduced through the following embodiments.

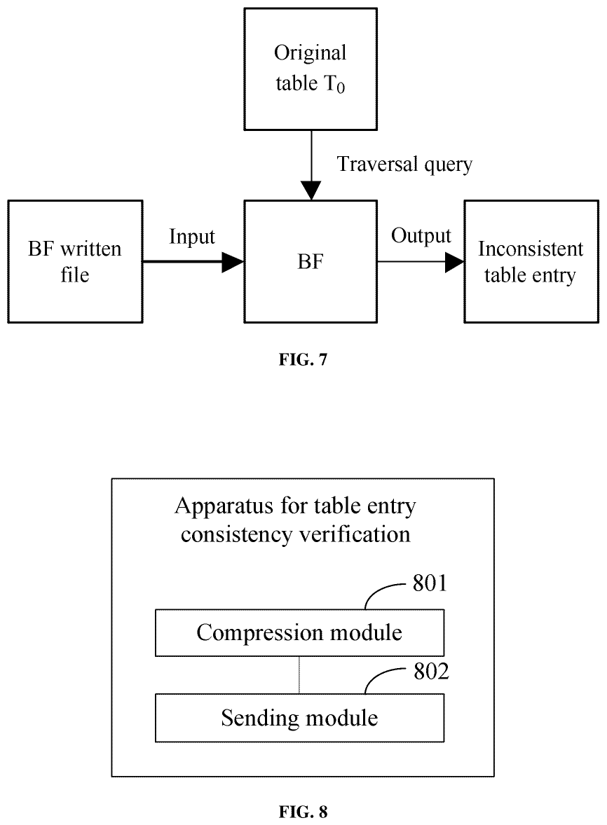

In some embodiments, the data plane node performs the probabilistic compression using the Bloom Filter to obtain the BF written file. As shown in FIG. 6, first, initialization parameters are input to perform initialization of the BF. The probabilistic compression is performed on the table entries of a configuration table T1 in the data plane node. For example, each table entry of T1 is traversed, and each table entry is set as the key value. The concatenated string of the table entry and fields of the table entry, namely key+value, is inserted into the BF to output the BF written file. The data plane node sends the BF written file to the control plane. As shown in FIG. 7, the control plane reads the BF written file, extracts an original configuration table T0 from a configuration database and traverses to query whether the table entries and the fields of the table entries of T0 are in the BF written file, so as to output some table entries or some fields of table entries that are not in the BF written file, namely the inconsistent table entries.

The BF initialization parameters are as shown in Table 1.

| | | recommended |
|---|---|---|
| parameter | description | setting |
| m | the length of BF, i.e., BF consumes | |
| | m bits | |
| n | the number of elements inserted into | actual number of |
| | BF | elements to be |
| | | inserted |
| k | the number of hash functions used by | 12 |
| | BF | |
| C | load factor, c = m/n, i.e., on | 50 |
| | average each element consumes c bits | |
| seeds | the seeds used by the hash functions | seeds are randomly |
| | of BF, seeds[i] indicates ith seed | generated each time |
| | | BF is initialized |
| data | the bit vector of BF, totaling m bits, | |
| | data[i] indicates ith bit | |
| f | false positive | f = (1 − e\hat{ }{−k/c})\hat{ }k = |
| | f = (1 − (1 − 1/m)^{nk})^{k} ≈ (1 − e^{-nk/m})^{k} | (1 − e\hat{ }{−12/50})\hat{ }12 = |
| | | 8.9e−09 < 10\hat{ } − 8 |

An initialization process is described in conjunction with Table 1 as follows.

The number of elements to be inserted into the BF during initialization is BF·n=|T1| (the number of table entries in T1).

The load factor of the BF during initialization is BF·c=50.

The length of the BF during initialization is BF·m=c*n.

The number of hash functions for the BF during initialization is BF·k=12 (by setting different seeds for the same hash function to simulate different hash functions).

Initialization of seeds used by the hash functions of the BF, where each hash function generates a seed randomly, is {BF·seeds[i]=random|0≤i<k}.

All bits in the bit vector of the BF are initialized to 0, {BF·data[i]=010≤i<m}.

A process of inserting T1 into the BF by the data plane node is as follows.

One, all elements, including the table entries and the fields of table entries (key, value), in T1 are traversed.

Two, the two types of elements to be inserted are separately calculated, including: a table entry string str1←key, and a concatenated string of the table entry and fields of the table entry str2←key+value.

Three, for each element, k hash functions are calculated, and the corresponding bit is set to 1, BF·data[loc]←1, to obtain the bit vector.

A BF query process on the control plane is as follows.

One, BF (m, n, k, c, seeds, data) is restored from the received BF file.

Two, all elements in T0 (key, value) are traversed.

Three, the two types of elements to be queried are separately calculated, including: str1←key, str2←key+value.

Four, for each element, k hash functions are calculated, and when the corresponding bit is found to be 0, the query fails.

Five, when the query for key fails, it indicates that the table entry is missing in the BF.

Six, when the query for key succeeds but the query for key+value fails, it indicates inconsistency in the fields of the table entry corresponding to key.

Corresponding to application scenarios and methods provided by the embodiments of the present disclosure, the embodiments of the present disclosure further provide an apparatus for table entry consistency verification. As shown in FIG. 8, FIG. 8 is a structural block diagram of an apparatus for table entry consistency verification according to some embodiments of the present disclosure. The apparatus for table entry consistency verification includes:
a compression module 801, arranged for at least performing probabilistic compression on at least entries of a first configuration table, to obtain a compressed first configuration table:
a sending module 802, arranged for sending the compressed first configuration table to a control plane, thereby enabling the control plane to: compare a second configuration table with the compressed first configuration table, and determine whether the at least entries of the first configuration table are consistent with at least entries of the second configuration table based on the comparison result

Through the apparatus for table entry consistency verification provided by the embodiments of the present disclosure, the data plane node of the SDN at least performs the probability compression on at least entries of a first configuration table, to obtain the compressed first configuration table and sends the compressed first configuration table to the control plane, and the control plane compares the second configuration table with the compressed first configuration table, and determines whether the at least entries of the first configuration table are consistent with at least entries of the second configuration table according to a comparison result. In embodiments of the present disclosure, time for data transmission can be reduced by performing the probability compression on the first configuration table and sending the compressed first configuration table to the control plane; and the comparison complexity and time for comparison can be reduced by comparing the second configuration table with the compressed first configuration table, thereby shortening time for table entry consistency verification of configuration tables having ten million-level table entries from tens of minutes to less than one minute, thus improving the table entry consistency verification efficiency of the data plane and the control plane.

In some embodiments, the compression module 801 is further arranged for calculating the at least entries of the first configuration table based on a hash function to obtain multiple first hash values; and obtaining a first bit vector, as the compressed first configuration table, corresponding to the first configuration table based on the multiple first hash values, where the multiple first hash values corresponding bit by bit to the first bit vector.

In some embodiments, the compression module 801 is further arranged for, when calculating the at least entries of the first configuration table based on a hash function to obtain multiple first hash values, randomly generating multiple first hash parameters, and calculating the at least entries of the first configuration table and the multiple first hash parameters based on the hash function to obtain the multiple first hash values corresponding to the at least entries of the first configuration table.

In some embodiments, the compression module 801 is further arranged for performing the probabilistic compression based on the at least entries of the first configuration table and fields of the at least entries of the first configuration table, to obtain the compressed first configuration table.

In some embodiments, the compression module 801 is further arranged for, performing the probabilistic compression based on the at least entries of the first configuration table and fields of the at least entries of the first configuration table to obtain the compressed first configuration table, determining multiple second hash values based on a concatenated string obtained by concatenating the at least entries of the first configuration table and the fields of the at least entries of the first configuration table; and obtaining a second bit vector, as the compressed first configuration table, corresponding to the first configuration table based on the multiple first hash values and the multiple second hash values obtained by calculating the at least entries of the first configuration table using the hash function, where the multiple first hash values and the multiple second hash values respectively corresponding bit by bit to the second bit vector.

In some embodiments, the compression module 801 is further arranged for, when determining the multiple second hash values based on the concatenated string obtained by concatenating the at least entries of the first configuration table and the fields of the at least entries of the first configuration table, randomly generating multiple second hash parameters, and calculating the concatenated string and the multiple second hash parameters based on the hash function to obtain the multiple second hash values corresponding to the concatenated string.

Corresponding to application scenarios and methods provided by the embodiments of the present disclosure, the embodiments of the present disclosure further provide another apparatus for table entry consistency verification. As shown in FIG. 9, FIG. 9 is a structural block diagram of another apparatus for table entry consistency verification according to some embodiments of the present disclosure. The apparatus for table entry consistency verification includes:
a receiving module 901, arranged for receiving a compressed first configuration table sent by a data plane node, the compressed first configuration table being obtained through at least performing, by the data plane node, probabilistic compression on at least entries of the first configuration table;
a comparison module 902, arranged for comparing a second configuration table with the compressed first configuration table, and determining whether the at least entries of the first configuration table are consistent with at least entries of the second configuration table based on the comparison result.

Through the apparatus for table entry consistency verification provided by the embodiments of the present disclosure, the data plane node of the SDN at least performs the probability compression on at least entries of a first configuration table, to obtain the compressed first configuration table and sends the compressed first configuration table to the control plane, and the control plane compares the second configuration table with the compressed first configuration table, and determines whether the at least entries of the first configuration table are consistent with at least entries of the second configuration table according to a comparison result. In embodiments of the present disclosure, time for data transmission can be reduced by performing the probability compression on the first configuration table and sending the compressed first configuration table to the control plane; and the comparison complexity and time for comparison can be reduced by comparing the second configuration table with the compressed first configuration table, thereby shortening time for table entry consistency verification of configuration tables having ten million-level table entries from tens of minutes to less than one minute, thus improving the table entry consistency verification efficiency of the data plane and the control plane.

In some embodiments, the comparison module 902 is further arranged for querying whether the at least entries of the second configuration table are in the compressed first configuration table, and in response to the at least entries of the second configuration table being in the compressed first configuration table, determining that the at least entries of the first configuration table are consistent with the at least entries of the second configuration table.

In some embodiments, the comparison module 902 is further arranged for in response to the at least entries of the second configuration table being in the compressed first configuration table, querying whether the fields of the at least entries of the first configuration table are in the compressed first configuration table, and in response to the fields of the at least entries of the first configuration table being in the compressed first configuration table, determining that the at least entries of the first configuration table are consistent with the at least entries of the second configuration table.

In some embodiments, the comparison module 902 is further arranged for in response to the table entries or fields of the at least entries of the second configuration table being not in the compressed first configuration table, generating an inconsistency notification message for the at least entries of the second configuration table, the inconsistency notification message comprising the table entries or fields of the at least entries of the second configuration table being not found in the compressed first configuration table.

The functions of each module within the apparatuses of the embodiments of the present disclosure can refer to the corresponding descriptions in the aforementioned methods and possess corresponding beneficial effects. For these, no further elaboration is provided.

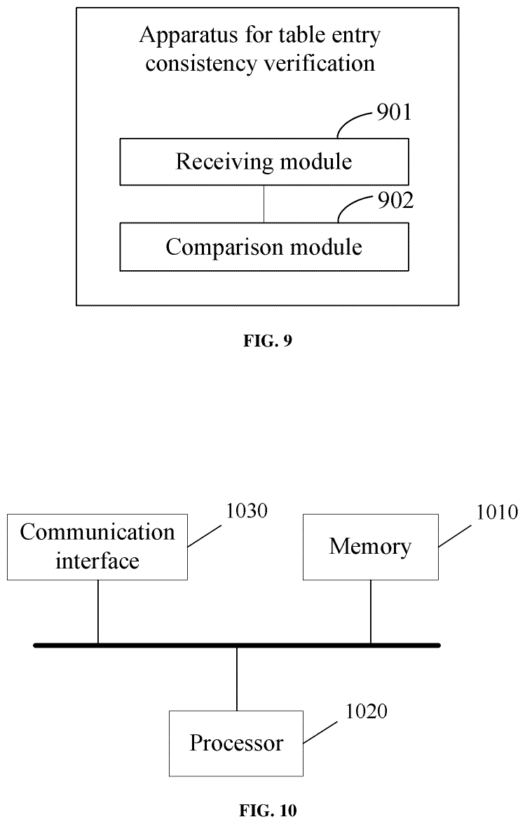

FIG. 10 is a block diagram of an electronic device according to some embodiments of the present disclosure. As shown in FIG. 10, the electronic device includes: a memory 1010 and a processor 1020. The memory 1010 stores a computer program that can run on the processor 1020. When executing the computer program, the processor 1020 implements the methods described in the aforementioned embodiments. The number of the memory 1010 and the number of the processor 1020 can be at least one.

The electronic device further includes: a communication interface 1030, arranged for communicating with external devices to perform data interaction and transmission.

In response to the memory 1010, the processor 1020, and the communication interface 1030 being implemented independently, the memory 1010, the processor 1020, and the communication interface 1030 can be interconnected via a bus to complete communication with each other. The bus can be an Industry Standard Architecture (ISA) bus, a Peripheral Component Interconnect (PCI) bus, an Extended Industry Standard Architecture (EISA) bus, etc. The bus can be divided into an address bus, a data bus, a control bus, etc. For ease of representation, FIG. 10 shows one thick line, but this does not indicate that there is only one bus or only one type of bus.

In some embodiments, when the memory 1010, the processor 1020, and the communication interface 1030 are integrated on a single chip, the memory 1010, the processor 1020, and the communication interface 1030 can complete communication with each other through an internal interface.

The embodiments of the present disclosure further provide a computer-readable storage medium, which stores a computer program. When the program is executed by the processor, the program realizes the method provided by the embodiments of the present disclosure.

The embodiments of the present disclosure further provide a chip, including a processor for calling and running instructions stored on a memory from the memory, so that a communication equipment installed with the chip performs the method provided by the embodiments of the present disclosure.

The embodiments of the present disclosure further provide another chip, including: an input interface, an output interface, a processor, and a memory. The input interface, the output interface, the processor, and the memory are connected through internal connection paths. The processor is arranged for executing codes stored on the memory, and when the codes is executed, the processor is arranged for performing the method provided by the embodiments of the present disclosure.

It should be understood that the above-mentioned processor can be a Central Processing Unit (CPU), or other general-purpose processors, a Digital Signal Processor (DSP), an Application Specific Integrated Circuit (ASIC), a Field Programmable Gate Array (FPGA), or other programmable logic devices, discrete gates or transistor logic devices, discrete hardware components, etc. The general-purpose processor can be a microprocessor or any conventional processor, etc. It should be noted that the processor can be a processor supporting an Advanced RISC Machines (ARM) architecture.

In some embodiments, the above-mentioned memory includes a read-only memory and a random access memory. The memory is a transitory memory or a non-transitory memory, or the memory includes both the transitory memory and the non-transitory memory. The non-transitory memory includes a Read-Only Memory (ROM), a Programmable ROM (PROM), an Erasable PROM (EPROM), an Electrically EPROM (EEPROM), or a flash memory. The transitory memory includes a Random Access Memory (RAM), which serves as an external high-speed cache. By way of example but not limitation, many forms of RAM are available, such as Static RAM (SRAM), Dynamic Random Access Memory (DRAM), Synchronous DRAM (SDRAM), Double Data Rate SDRAM (DDR SDRAM), Enhanced SDRAM (ESDRAM), Sync link DRAM (SLDRAM) and Direct Rambus RAM (DR RAM).

Compared with the related art, the embodiments of the present disclosure have the following advantages.

Through the method for table entry consistency verification, the electronic device and the storage medium provided by the embodiments of the present disclosure, the data plane node of the SDN at least performs the probability compression on at least entries of a first configuration table, to obtain the compressed first configuration table and sends the compressed first configuration table to the control plane, and the control plane compares the second configuration table with the compressed first configuration table, and determines whether the at least entries of the first configuration table are consistent with at least entries of the second configuration table according to a comparison result. In embodiments of the present disclosure, time for data transmission can be reduced by performing the probability compression on the first configuration table and sending the compressed first configuration table to the control plane; and the comparison complexity and time for comparison can be reduced by comparing the second configuration table with the compressed first configuration table, thereby shortening time for table entry consistency verification of configuration tables having ten million-level table entries from tens of minutes to less than one minute, thus improving the table entry consistency verification efficiency of the data plane and the control plane.

The above embodiments can be implemented in whole or in part through software, hardware, firmware, or any combination thereof. When implemented using software, the above embodiments can be realized in whole or in part in the form of a computer program product. A computer program product includes at least one computer instruction. When the at least one computer program instruction is loaded and executed on a computer, the processes or functions in accordance with the present disclosure are fully or partially generated. The computer can be a general-purpose computer, a dedicated computer, a computer network, or other programmable devices. The at least one computer instruction can be stored on a computer-readable storage medium or transmitted from one computer-readable storage medium to another computer-readable storage medium.

In the description of this specification, reference terms such as “one embodiment”, “some embodiments”, “example”, “specific example”, or “some examples” refer to specific features, structures, materials, or characteristics described in conjunction with the embodiment or example being contained in at least one embodiment or example of the present disclosure. The specific features, structures, materials, or characteristics can be combined in any at least one embodiment or example in a suitable manner. In addition, a person having ordinary skill in the art can combine and splice different embodiments or examples described in this specification and the features of different embodiments or examples without mutual contradiction. Moreover, the terms “first”, “second” are used for descriptive purposes and should not be construed as indicating or implying relative importance or implicitly specifying the quantity of the technical features indicated. Therefore, the features defined by “first” and “second” can explicitly or implicitly include at least one such feature. In the description of the present disclosure, unless otherwise specified, “multiple” means at least two.

The process or method described in the flowchart or otherwise described herein can be understood as representing code modules, segments, or portions of executable instructions that implement specific logical functions or processes. And the scope of exemplary embodiments of the present disclosure includes other implementations where the functions may be performed in an order not shown or discussed, including substantially concurrent or in reverse order, according to the involved functions. The logic and/or steps described in the flowchart or otherwise described herein, for example, can be considered as an ordered list of executable instructions for implementing logical functions, which can be specifically embodied in any computer-readable medium for use by an instruction execution system, apparatus, or device (such as a computer-based system, a system including a processor, or other systems that can fetch instructions from an instruction execution system, apparatus, or device and execute the instructions) or in combination with these instruction execution systems, apparatuses, or devices.

It should be understood that the various parts of the present disclosure can be implemented using hardware, software, firmware, or combinations thereof. In the above implementation methods, multiple steps or methods can be implemented with software or firmware stored on memory and executed by an appropriate instruction execution system. The entire or partial steps of the exemplary method embodiments can be completed by a program instructing related hardware, which can be stored on a computer-readable storage medium. When the program is executed, the program includes at least one step of the method embodiment or combinations of the steps.

Furthermore, the functional units in the various embodiments of the present disclosure can be integrated into one processing module, or the functional units can exist separately, or at least two units can be integrated into one module. The aforementioned integrated module can be implemented in the form of hardware or software function modules. If the integrated module is implemented in the form of a software function module and sold or used as an independent product, the integrated module can further be stored on a computer-readable storage medium. The storage medium can be a read-only memory, a magnetic disk, an optical disc, etc.

All of the above are exemplary embodiments of the present disclosure, but the protection scope of the present disclosure is not limited thereto. Any variations or substitutions that a person having ordinary skill in the art can easily conceive within the technical scope disclosed by the present disclosure shall be covered by the protection scope of the present disclosure. Therefore, the protection scope of the present disclosure should be determined by the claims.

1. A method for table entry consistency verification, wherein the method is applied to a data plane node in a Software Defined Networking (SDN), the method comprising:
at least performing probabilistic compression on at least entries of a first configuration table, to obtain a compressed first configuration table; and
sending the compressed first configuration table to a control plane, thereby enabling the control plane to:
compare a second configuration table with the compressed first configuration table, and
determine whether the at least entries of the first configuration table are consistent with at least entries of the second configuration table based on the comparison result.

2. The method according to claim 1, wherein at least performing the probabilistic compression on the at least entries of the first configuration table, to obtain the compressed first configuration table, comprises:
calculating the at least entries of the first configuration table based on a hash function to obtain a plurality of first hash values; and
obtaining a first bit vector, as the compressed first configuration table, corresponding to the first configuration table based on the plurality of first hash values, wherein the plurality of first hash values corresponding bit by bit to the first bit vector.

3. The method according to claim 2, wherein calculating the at least entries of the first configuration table based on the hash function to obtain the plurality of first hash values, comprises:
randomly generating a plurality of first hash parameters, and calculating the at least entries of the first configuration table and the plurality of first hash parameters based on the hash function to obtain the plurality of first hash values corresponding to the at least entries of the first configuration table.

4. The method according to claim 1, wherein at least performing the probabilistic compression on the at least entries of the first configuration table, to obtain the compressed first configuration table, comprises:
performing the probabilistic compression based on the at least entries of the first configuration table and fields of the at least entries of the first configuration table, to obtain the compressed first configuration table.

5. The method according to claim 4, wherein performing the probabilistic compression on the at least entries of the first configuration table and the fields of the at least entries of the first configuration table, to obtain the compressed first configuration table, comprises:
determining a plurality of second hash values based on a concatenated string obtained by concatenating the at least entries of the first configuration table and the fields of the at least entries of the first configuration table; and
obtaining a second bit vector, as the compressed first configuration table, corresponding to the first configuration table based on the plurality of first hash values and the plurality of second hash values obtained by calculating the at least entries of the first configuration table using the hash function, wherein the plurality of first hash values and the plurality of second hash values respectively corresponding bit by bit to the second bit vector.

6. The method according to claim 5, wherein determining the plurality of second hash values based on the concatenated string obtained by concatenating the at least entries of the first configuration table and the fields of the at least entries of the first configuration table, comprises:
randomly generating a plurality of second hash parameters, and calculating the concatenated string and the plurality of second hash parameters based on the hash function to obtain the plurality of second hash values corresponding to the concatenated string.

7. A method for table entry consistency verification, wherein the method is applied to a control plane of an SDN, the method comprising:
receiving a compressed first configuration table sent by a data plane node, the compressed first configuration table being obtained through at least performing, by the data plane node, probabilistic compression on at least entries of the first configuration table; and
comparing a second configuration table with the compressed first configuration table, and determining whether the at least entries of the first configuration table are consistent with at least entries of the second configuration table based on the comparison result.

8. The method according to claim 7, wherein comparing the second configuration table with the compressed first configuration table, and determining whether the at least entries of the first configuration table are consistent with the at least entries of the second configuration table based on the comparison result, comprises:
querying whether the at least entries of the second configuration table are in the compressed first configuration table, and in response to the at least entries of the second configuration table being in the compressed first configuration table, determining that the at least entries of the first configuration table are consistent with the at least entries of the second configuration table.

9. The method according to claim 7, wherein in response to the compressed first configuration table being obtained through performing the probabilistic compression based on the at least entries of the first configuration table and the fields of the at least entries of the first configuration table, comparing the second configuration table with the compressed first configuration table, and determining whether the at least entries of the first configuration table are consistent with the at least entries of the second configuration table based on the comparison result, comprises:
in response to the at least entries of the second configuration table being in the compressed first configuration table, querying whether the fields of the at least entries of the first configuration table are in the compressed first configuration table, and in response to the fields of the at least entries of the first configuration table being in the compressed first configuration table, determining that the at least entries of the first configuration table are consistent with the at least entries of the second configuration table.

10. The method according to claim 7, wherein in response to the compressed first configuration table being obtained through performing the probabilistic compression based on the at least entries of the first configuration table and the fields of the at least entries of the first configuration table, comparing the second configuration table with the compressed first configuration table, and determining whether the at least entries of the first configuration table are consistent with the at least entries of the second configuration table based on the comparison result, comprises:
in response to the table entries or fields of the at least entries of the second configuration table being not in the compressed first configuration table, generating an inconsistency notification message for the at least entries of the second configuration table, the inconsistency notification message comprising the table entries or fields of the at least entries of the second configuration table being not found in the compressed first configuration table.

11. An electronic device, comprising a memory, a processor, and a computer program stored on the memory, wherein when executing the computer program, the processor implements the following steps:
at least performing probabilistic compression on at least entries of a first configuration table, to obtain a compressed first configuration table; and
sending the compressed first configuration table to a control plane, thereby enabling the control plane to:
compare a second configuration table with the compressed first configuration table, and
determine whether the at least entries of the first configuration table are consistent with at least entries of the second configuration table based on the comparison result.

12. (canceled)

13. The method according to claim 2, wherein at least performing the probabilistic compression on the at least entries of the first configuration table, to obtain the compressed first configuration table, comprises:
performing the probabilistic compression based on the at least entries of the first configuration table and fields of the at least entries of the first configuration table, to obtain the compressed first configuration table.

14. The method according to claim 3, wherein at least performing the probabilistic compression on the at least entries of the first configuration table, to obtain the compressed first configuration table, comprises:
performing the probabilistic compression based on the at least entries of the first configuration table and fields of the at least entries of the first configuration table, to obtain the compressed first configuration table.

15. The method according to claim 1, wherein the first configuration table is a configuration table issued from the control plane to the data plane.

16. The method according to claim 15, wherein the first configuration table comprises a plurality of table entries, and the plurality of table entries are any dimensional information which is required to be configured in network configurations.

17. The method according to claim 1, wherein each table entry of the first configuration table is traversed, and the each table entry is inserted as a key value into a Bloom Filter to output the compressed first configuration table.

18. The method according to claim 1, wherein the second configuration table is an original network configuration table stored on the control plane.

19. The method according to claim 17, wherein when the data plane node performs the probabilistic compression through the Bloom Filter, the control plane queries each table entry of the second configuration table in the compressed first configuration table, and in response to at least one table entry being not in the compressed first configuration table, it is indicated that the inconsistency is existed between the at least entries of the first configuration table and the table entries of second configuration table.

20. The method according to claim 3, wherein each of the plurality of first hash parameters is a seed of the hash function generated using a random function, and the same hash function is used for respectively calculating one table entry and a plurality of seeds to obtain the plurality of first hash values.

21. The method according to claim 6, wherein each of the plurality of second hash parameters is a seed of the hash function generated using a random function, and the same hash function is used for respectively calculating one concatenated string and a plurality of seeds, to obtain the plurality of second hash values.
